(19) United States
(12) Patent Application Publication
(10) Pub. No.: US 2005/0276084 A1
(43) Pub. Date: Dec. 15, 2005

(54) Current source sine wave voltage driving circuit via voltage-clamping and soft-switching techniques

(75) Inventors: Rong-Jong Wai, Liouying Township (TW); Rou-Yong Duan, Guosing Township (TW)

Correspondence Address: APEX JURIS, PLLC, 13194 EDGEWATER LANE NORTHEAST, SEATTLE, WA, 98125, US

(73) Assignee: Yuan Ze University, Jhongli City (TW)

(21) Appl. No.: 10/864,714

(22) Filed: Jun. 9, 2004

(51) Int. Cl. H02M 3/335

(52) U.S. Cl. 363/98

(57) ABSTRACT

In this invention, a current-source sine wave voltage driving circuit via voltage-clamping and soft-switching techniques, also known as an inverter, is applied mainly to the fuel cell, solar energy, battery and un-interruptible power systems for inverting DC voltage into utility AC voltage. A controllable current source having high frequency switching capability is used for supplying output capacitors and loads with an output sine wave voltage. The current source uses the voltage-clamping technique and quasi-resonant property to control the inductance current in discontinuous conduction mode so that all loads have soft-switching characteristics and more-than-95% maximum conversion efficiency. Meanwhile, the voltage-clamping technique can reduce voltage specification requirement to be sustained by the switch devices. The value and volume of inductors in the current source are smaller than those in a conventional current-source mechanism, so it can adjust the inductive current promptly to satisfy the requirement of the loads.

### BACKGROUND OF THE INVENTION

1. Field of the Invention

The present invention relates to a current-source sine wave voltage driving circuit using voltage-clamping and soft-switching techniques, more particularly it relates to a current-source sine wave voltage driving circuit using voltage-clamping and soft-switching techniques, which converts a DC source to an AC sine wave voltage using the difference between the AC sine wave voltage command and the feedback voltage to control the turn-on time of switches, and using an inductor to generate a current source to charge capacitors via positive/negative cycles of full-bridge switch to adjust a rise and fall range of voltage to provide linear voltage regulation.

2. Description of the Prior Art

Presently there are two kinds of products which can convert a DC source to 60 Hz AC voltage: one is inverter of AC motor, which uses coil inductor of motor and PWM (pulse width modulation) technique to generate sine-wave-like current, however, it is not suitable for resistive or capacitive loads, therefore basically inverter is not for home appliances or computer products; the other is a modification of the first, such as UPS (Un-interruptible Power Supply), which adds an LC filter circuit at the output and a feedback circuit to provide constant voltage, regardless of various loads and input voltages. Besides, batteries and charging/discharging circuits are often included to provide a back-up power source in addition to the utility power. Taiwan has become a leader in UPS products and related techniques, nevertheless, there are a few issues that still need to be solved.

Firstly, output current has to pass through a filter inductor, and in consideration of the −3 dB response of second order resonance circuit, common UPS has an mH-level of inductance, therefore the filter inductor increases the product's weight and energy transfer loss.

Secondly, the voltage L·di/dt between the two ends of inductor is the difference between the DC voltage and the output voltage. While the minimum value occurs around the sine wave peak, the output waveform tends to distort around the peak turning point and generates high-frequency harmonic components due to the filter inductor. This is inevitable even with higher filter voltage and even though the inductor is intended for filter use it also limits the regulation ability under loads that are suddenly varied.

Thirdly, a few kinds of loads, such as half-wave rectifying loads or highly inductive loads, could harm the driving circuit due to the symmetry of the LC filter circuit waveform, and highly inductive loads could change the frequency response of second order filter circuit as well. DC voltage levels have to be raised in case the output sine wave voltage is too low, and consequently the system could be damaged due to overly high voltage.

Fourthly, the voltage distortion rate of non-resistive loads, generally referred to as Total Harmonic Distortion (THD), is far greater than resistive loads because the traditional second order filter circuit is not capable of handling non-resistive loads, such as inductive, capacitive and nonlinear loads.

Besides, switching loss increases as switching frequency rises, which in turn decreases the system efficiency, many manufacturers started to apply various soft-switching techniques to high power switches, several papers prove that decreases the PWM switching loss will help to increase switching frequency and improve output voltage waveform.

Compared to traditional PWM methods, the sine wave voltage of the current source inverter is mostly used for charging the capacitor to accumulate sine wave voltage under various loads and frequency changes. However, due to the large inductor used in current source, it's hard to control the inductor circuit and to realize soft-switching techniques, resonant voltage and high current issues are difficult to overcome. Recently the Institute of Electrical and Electronic Engineers (IEEE) proposed a voltage-clamping technique to handle current source inverter [1] (please refer to the appendix), the circuit exhibited soft-switching characteristics, which also restrains the switch voltage under the factor of 4. Nevertheless, if the imaginary part of the inductor current in the current source is too high, it's difficult to decrease the volume. Besides, issues such as high ripples in the voltage waveform, no field experiment available and the driving object being an inductance motor still exist.

Therefore, the above-mentioned devices present several shortcomings to be overcome.

In view of the above-described deficiencies of prior-art devices, and after years of constant effort in research, the inventor of this invention has consequently developed and proposed a current-source sine wave voltage driving circuit using voltage-clamping and soft-switching techniques.

### SUMMARY OF THE INVENTION

The object of the present invention is to provide a current-source sine wave voltage driving circuit, which uses voltage-clamping and soft-switching techniques to use voltage-clamping technique and quasi-resonant property, and to control the inductance current in discontinuous conduction mode so that all semiconductor switches and diodes have the soft-switching characteristics and so that the maximum convention efficiency is more than 95%.

It is another object of the present invention to provide a current-source sine wave voltage driving circuit, which uses a voltage-clamping technique to reduce the voltage specification to be sustained by the switch devices.

It is another object of the present invention to provide a current-source sine wave voltage driving circuit using voltage-clamping and soft-switching techniques, which can do without output filter inductors and can charge the output loads and filter capacitors directly, making it suitable for various inductive, capacitive and nonlinear loads, even loads that change abruptly, and the analysis results of Fourier spectrum and voltage distortion are superior to the traditional PWM scheme.

The current-source sine wave voltage driving circuit using voltage-clamping and soft-switching techniques, such as:

1. voltage-clamping: using the conservation of magnetic flux in the transformer to force the system to operate in a designated voltage range, therefore voltage specification to be sustained by the components, and the components, cost will be reduced.

2. quasi-resonant property: using the continuous voltage property of the LC resonance circuit to enable ZVS (Zero Voltage Switching) effects for all switches and diodes.

3. controlling the inductance current in discontinuous conduction mode: to let the inductor current rise from 0 to turn on the switches and diodes at zero current (Zero Current Switching, ZCS).

These features and advantages of the present invention will be fully understood and appreciated from the following detailed description of the accompanying Drawings.

### BRIEF DESCRIPTION OF THE DRAWINGS

FIG. 1 illustrates a block diagram of the current-source sine wave voltage driving circuit using voltage-clamping and soft-switching techniques;

FIG. 2 illustrates the working modes of the current-source sine wave voltage driving circuit using voltage-clamping and soft-switching techniques;

FIG. 3 illustrates various waveforms of components of the current-source sine wave voltage driving circuit using voltage-clamping and soft-switching techniques;

FIG. 4 shows the implementation of the current-source sine wave voltage driving circuit using voltage-clamping and soft-switching techniques;

FIG. 5 shows the real voltages and soft-switching current waveforms of switches and diodes in the current-source sine wave voltage driving circuit using voltage-clamping and soft-switching techniques;

FIG. 6 (a), (c), (e), (g) shows the comparison of the current-source sine wave voltage driving circuit using voltage-clamping and soft-switching techniques, and the traditional PWM inverter under the same test environment; and

FIG. 6 (b), (d), (f), (h) shows the output voltage/current waveforms and response waveforms under various loads of the current-source sine wave voltage driving circuit using voltage-clamping and soft-switching techniques.

### DETAILED DESCRIPTION OF THE PREFERRED EMBODIMENT

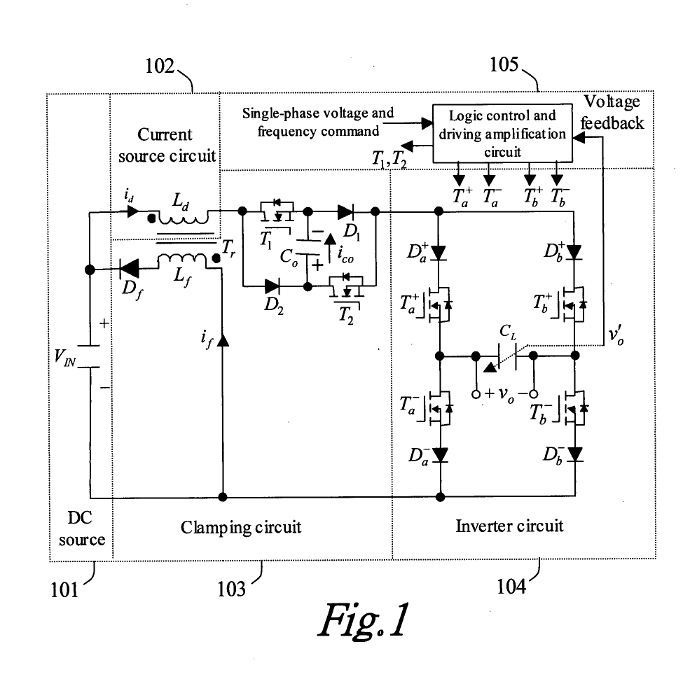

FIG. 1 illustrates a block diagram of the current-source sine wave voltage driving circuit using voltage-clamping and soft-switching techniques. When the output voltage is at the upper half cycle of the sine wave, current flows from DC source 101 through inductor L_{d} of the current source circuit 102 and switches T₁, T₂ of the clamping circuit 103, then via switches Tₐ⁺, T_{b}⁻ of the inverter circuit 104 to charge the output capacitor C_{L}. Similarly, when the output voltage is at the lower half cycle of the sine wave, switches T₁, T₂, Tₐ⁺, Tₐ⁻ turn on at the same time to discharge the output capacitor C_{L}. The inductor L_{d} of the current source circuit 102 is placed among voltage sources V_{IN}, V_{Co} and Vₒ, to limit the current value, the ascending rate of the inductor current being proportional to voltage applied to the inductor. The symbol L_{d} and L_{f} are primary side and secondary side of a transformer with high exciting current, respectively.

There are four purposes to the clamping circuit 103: First, it is cascaded with the inverter circuit to control switches T₁, T₂ to turn on/off the inverter current. Second, capacitor Cₒ and diodes D₁, D₂ all connect either sides of T₁ and T₂ to enable ZVS property of T₁ and T₂ when they cut off. Third, when the primary side of the transformer is forward-biased (the polarity of the black spots in FIG. 1 is positive), diode D_{f} is reverse-biased, current does not flow through the secondary side, and current on the primary side stores energy at transformer Tᵣ. During switches T₁ and T₂ turn off, the primary side of transformer Tᵣ reverse voltage polarity (the polarity of the black spots is negative), diode D_{f} is forward-biased. Due to diode D_{f} conduction, the current i_{f} on the secondary side will release the energy stored in the transformer to DC source 101, therefore the current is also referred to as feedback current. At the energy releasing time, the voltage value of the secondary side of transformer Tᵣ is the same as the source's (while the voltage drop of diode and resistance should be ignored), and the voltage value of the primary side will be limited by turns ratio. The turns ratio of the present invention was designed to one, therefore, the structure disclosed herein is able to clamp two times the voltage of DC source 101. Finally, when the current i_{f} on the secondary side is zero all the stored energy in the transformer has been released, then if any switches on the primary side turns on, it will have ZCS property for the initial current of the inductor L_{d} and it is zero. Therefore, the clamping circuit not only limits the highest voltage of the system, but it also provides soft-switching effects. Inverter circuit 104 is implemented in full-bridge structure using switches cascaded with diodes, so there won't be a short circuit path for the output capacitor. The inductor L_{d} current charges the output capacitor C_{L}, and sine wave output voltage value can be obtained by integration. Control and driving circuit 105 generates the driving signal, which compares 60 Hz single-phase voltage command with feedback voltage, then the control and driving circuit sends the driving signal to six switches. The diagonal switches of the full-bridge inverter, (Tₐ⁺, T_{b}⁻) and (Tₐ⁻, T_{b}⁺), are triggered via the bipolar mode with lockout operation. The trigger signals manipulated by a logic control circuit are delivered to the switches (T₁, T₂) in the clamping circuit 103 so that the bridge switches will be acted accordingly with the properties of ZCS and ZVS.

Detailed descriptions are as follows:

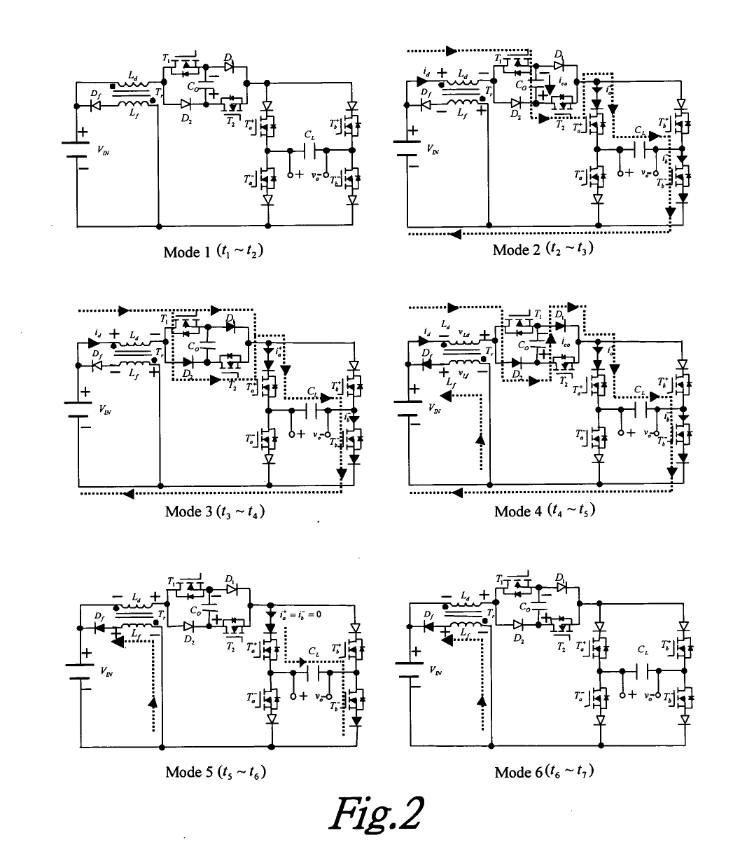

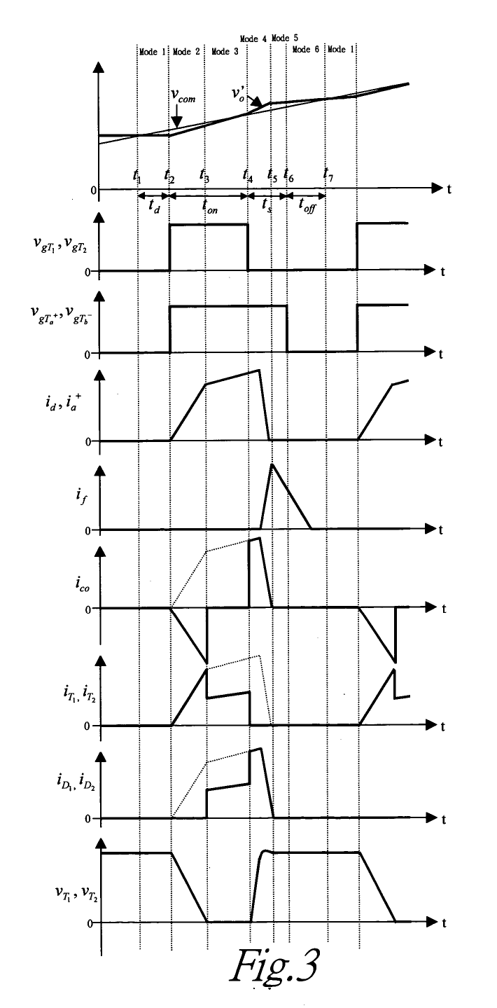

FIG. 2 shows various working modes of the driving circuit and FIG. 3 shows the waveforms at various points of the driving circuit. Based on FIG. 2 and FIG. 3, the working principles include:

1. Mode 1: time t₁˜t₂

As shown in mode 1 of FIG. 2, when feedback voltage v′ₒ is lower than single-phase voltage and frequency command v_{com}, all switches will not turn on immediately. After time t_{d}, switches T₁, T₂, Tₐ⁺ and T_{b}⁻ start to turn on, this period is called turn-on delay time. There are two purposes for this: firstly there will be enough time to release the magnetic flux stored inside the transformer. According to the theory of conservation of magnetic flux, anti-magnetomotive force will force the diode D_{f} to be forward-biased, using the feedback current i_{f} to release the transformer's energy and preparing for the next ZCS turn-on stage. Suppose the peak value of feedback current is i_{f max}, the time for feedback current to drop from peak value to zero is t_{f}, then
−L_{f}·di/dt=V_{IN} (1)

After doing integration of the above equation, the time needed for the feedback current of the secondary side of transformer to be cut off is:
t_{f}=L_{f}i_{f max}/V_{IN} (2)

When time t_{f} is very small the current in the transformer reduces to zero quickly and no current flows in coil, i.e., there is no loss in the transformer, therefore the overall system efficiency is improved. When time t_{d}>t_{f}, it is for sure that the magnetic flux in the transformer is zero, so it's necessary to estimate the maximum charging current of the output capacitor. Secondly, it is viable to limit the maximum switching frequency for switches, suppose the switching cycle to be:
T=t_{d}+tₒₙ+tₛ+t_{off} (3)

wherein tₒₙ is the turn-on time for switches T₁, T₂ of voltage-clamping circuit; tₛ is the cut-off delay time for T₁, T₂ in cut-off state and Tₐ⁺, T_{b}⁻ still in turn-on state; t_{off} is the time that output voltage is bigger than command voltage, and all six switches cut off. For t_{d} and tₛ are predefined value of the circuit, and tₒₙ, t_{off} depend on the loads and waveform, therefore the maximum value of switching frequency is:
fₛ₍ₘₐₓ₎<1/(t_{d}+tₛ) (4)

2. Mode 2: time t₂˜t₃

As shown in mode 2 of FIG. 2, before time t₂, all energy in transformer has been released, so the initial current of inductor L_{d} on the primary side is zero, and the inductor acts like a choke. At time t₂, switches T₁, T₂ and Tₐ⁺, T_{b}⁻ are triggered, current flowing through the loop forming by four switches, with its value building from zero, therefore when switches T₁, T₂ and Tₐ⁺, T_{b}⁻ turn on, they have ZCS properties. Suppose the initial voltage of capacitor Cₒ is V_{c}(0), the initial voltage of output capacitor C_{L} is Vₒ(0), and voltage and inductance leakage can be ignored, then the end-to-end voltage of inductor is the voltage of DC source adding that of Cₒ and C_{L}, which is:
V_{IN}=L_{d}·di/dt−v_{c}+vₒ (5)

Meanwhile the initial voltage of capacitor Cₒ will force diode D₁ and D₂ to be reversely-biased and cut off, so switches T₁ and T₂ cascading with above-mentioned voltage storage component are turning on; the initial voltage of capacitor Cₒ comes from the cut-off energy drained in Mode 4. From equation (5), it is known that increasing the climbing rate of initial inductor current, making it similar to inductor current in continuous mode, will reduce turn-on time and peak current value. The capacitor voltage is represented by:

$${v}_{c} = {V}_{c} ( 0 ) - \frac{1}{{C}_{o}} {\int }_{{t}_{2}}^{{t}_{3}} {i}_{d} ⅆ t {t}_{2} \leq t \leq {t}_{3} \qquad ( 6 )$$

3. Mode 3: time t₃˜t₄

According to Kirchhoff's Voltage Law, the end to end voltage of switches of clamping circuit should be:

$$\{ \begin{matrix}{V}_{{T}_{1}} = {V}_{{C}_{o}} + {V}_{{D}_{2}} \\ {V}_{{T}_{2}} = {V}_{{C}_{o}} + {V}_{{D}_{1}}\end{matrix} \qquad ( 7 )$$

therefore the end to end voltage of diodes D₁, D₂ are

$$\{ \begin{matrix}{V}_{{D}_{2}} = {V}_{{T}_{1}} - {V}_{{C}_{o}} \\ {V}_{{D}_{1}} = {V}_{{T}_{2}} - {V}_{{C}_{o}}\end{matrix} \qquad ( 8 )$$

When switches T₁, T₂ turn on, the end to end voltage will reduce to saturated voltage, and when capacitor Cₒ discharges to near 0 volt, the end to end voltage of diodes D₁, D₂ will move from reverse-bias to 0 volt then forward-bias, resulting in ZVS turn on state for diodes. The current i_{d} on the primary side will split into two parallel paths: T₁-D₁ and D₁-T₁ respectively, to charge the capacitor C_{L}, at this time the voltage of V_{C0} is low:
V_{C}_{ₒ}=V_{T}_{₁}−V_{D}_{₂}=V_{T}_{₂}−V_{D}_{₁} (9)

4. Mode 4: time t₄˜t₅

When the output feedback voltage is higher than command voltage, T₁ and T₂ trigger signals cut off, current flow turns to D₂, Cₒ and D₁, and the voltage V_{C}_{ₒ} of capacitor Cₒ rises, which means that the across voltage of switches T₁ and T₂ equals the voltage V_{C}_{ₒ}. Therefore, when both switches (T₁, T₂) cut off, they will have ZCS and ZVS properties. In the meantime, the current has the characteristics of semi-cascading resonance current of inductor L_{d} and capacitors Cₒ, C_{L}. In the present invention, L_{d}=L_{f}=200 uH, therefore,
V_{L}_{_{d}}=V_{IN}=(V_{c}_{ₒ}+vₒ)/2 ( 10)
While V_{L}_{_{f}} is equal to V_{IN}, which will force diode D_{f} to be forward-biased and turn on. According to conservation of magnetic flux, because the output voltage of the active loop at the secondary side is low, the magnetic flux stored by primary side current will feed back to DC source via the coil L_{d} of the secondary side. During the current crossover time between primary and secondary side, the voltages on both primary and secondary side will be dragged by V_{C}_{ₒ}, so the voltages are continuous. Therefore, when D₁, D₂ cut off and D_{f} turns on, they will all have ZVS and ZCS properties. From equation (10), when vₒ=0, V_{C}_{ₒ} has the peak value of 2V_{IN}, which determines the same voltage specification of switches T₁ and T₂.

5. Mode 5: time t₅˜t₆

When the feedback current begins to drop the inductor current i_{d} of primary side will all be transferred to secondary coil. At the same time, the current of the full-bridge switches is also zero, and the switch voltage is zero owing that cascading clamping circuit absorbs the voltage difference. The same can apply to cascaded Dₐ⁺, D_{b}⁻ pair, they both have ZCS and ZVS properties in cut off state. The voltage specification should conform to the condition that output voltage is reversely switching, therefore it is lower than the input DC voltage. The period between t₄˜t₆ is the crossover time for the primary and secondary side, which is referred to as cut-off delay time. At time t₆, the current on the primary side is zero and all switch signals may be shut down.

6. Mode 6: time t₆˜t₇

Time t₇ defines the beginning of the next cycle (v′ₒ=v_{com}) which means the output capacitor continuously discharges to power the loads, and the inductor feedback current continuously drops, besides, the length of time depends on the loads. In order to release the current until no magnetic flux is in the inductor and the current is in discontinuous mode for all switches turning on with ZCS characteristics, it is necessary to increase the turn-on delay time in mode 1. When feedback current i_{f}=0, the end to end voltage of D_{f} equals the disorderly resonance voltage of capacitor and inductor, with the resonance voltage starting from zero, and the diode D_{f} have both ZCS and ZVS properties in cut-off state. As to the switches Tₐ⁺, T_{b}⁻ and matched cascading diodes Dₐ⁺, D_{b}⁻ waiting to be turned on in the next stage, end to end voltages remain zero. From the analysis of mode 2, when they turn on, they all have ZCS and ZVS properties at the same time.

From above, when most diodes and switches cut off or turn on, they can keep the ZCS and ZVS properties at the same time, and the rest can provide at least one of zero-voltage or zero-current switching properties. Therefore, theoretically, the driving circuit disclosed in the present invention provides high transfer efficiency.

The table depicted below lists all soft-switching capabilities for all modes:

TABLE 1
soft-switching properties under various modes

| | |
|---|---|
| ZVS | ZCS |

| components | Turn-on | cut-off | Turn-on | cut-off |
|---|---|---|---|---|
| T₁, T₂ | | ∘ | ∘ | ∘ |
| Tₐ⁺, Tₐ⁻, T_{b}⁺, T_{b}⁻ | ∘ | ∘ | ∘ | ∘ |
| D₁, D₂ | ∘ | ∘ | | ∘ |
| Dₐ⁺, Dₐ⁻, D_{b}⁺, D_{b}⁻ | ∘ | ∘ | ∘ | ∘ |
| D_{f} | ∘ | ∘ | ∘ | ∘ |

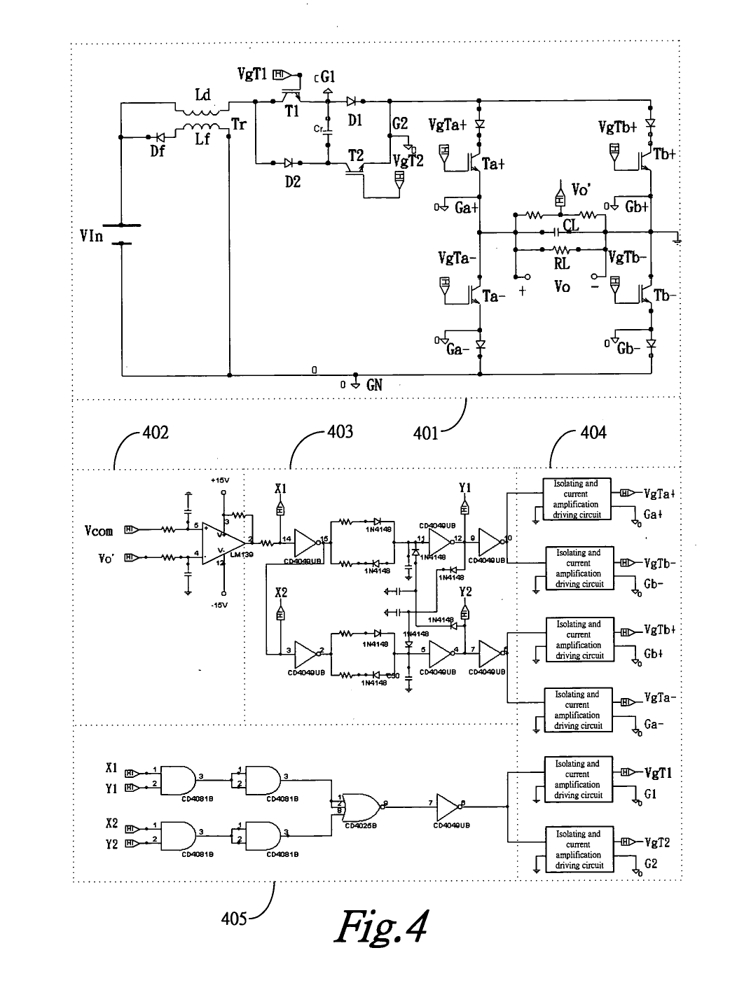

FIG. 4 shows the implementation of the current-source sine wave voltage driving circuit using voltage-clamping and soft-switching techniques. The main circuit 401 is the higher voltage side with large current, the specification for the circuit is:

V_{IN}=170V DC

vₒ=110V_{r.m.s}60 Hz

Switch: MOSFET IRFP360-400V

Inverter circuit diode: Schottky MBR20200CT-200V

Clamping circuit diode: SFI606G-400V

Tᵣ: EE-55 L_{d}=L_{f}=300 uH

Cₒ=0.047 uF

C_{L}=20 uF

Switching frequencies: 5 kHz˜20 kHz

In feedback control circuit 402, v_{com} is a 1.56 sin(2*π*60t) signal command. The feedback signal v′ₒ is 1/100of output AC voltage vₒ. In one embodiment, the output peak AC voltage is 156V, and the effective value is 110V. The two signals pass through a low-pass filter circuit to reach a comparator. The comparator outputs a resultant signal to phase splitting circuit 403, and the resultant signal is split to two sets of signals having a phase difference of 180 degrees. Each set of signals pass through two cascaded resistor-diode circuits, which form one stage RC discharging circuits with a same capacitor respectively to provide rise and fall delays to two sets of signals, and further provide turn-on (20 μs) and cut-off time (5 μs) delays via the inverter; meanwhile providing a lockout time (15 μs) needed for an upper path and a lower path of inverter switches to interlock each other. In order to deal with zero crossover voltage swing in a low load situation, the signal coming from Y1 or Y2 point passing through a circuit comprising two cascaded diodes and one capacitor to extend a turn-on time of another set of signals. Six sets of isolating and current amplification driving circuits 404 drive six independent switches to avoid a common-ground short-circuit phenomenon. The phase splitting circuit 403 connecting inverter uses Low Active optical coupling to isolate and amplify the output current to drive. Because any set of switches in inverter are in turn-on state, T₁, T₂ should turn on accordingly. The only difference among switches is the turn-on delay time. No cut-off delay time exists. The logic control circuit 405 process X1, Y1 and X2, Y2 with AND gate operation respectively to obtain the designated signals, later using OR gate operation to turn on any set of inverter signals. The connecting circuit isolates and amplifies the current driving circuits 404 via a phase-inverting device to drive in low voltage level.

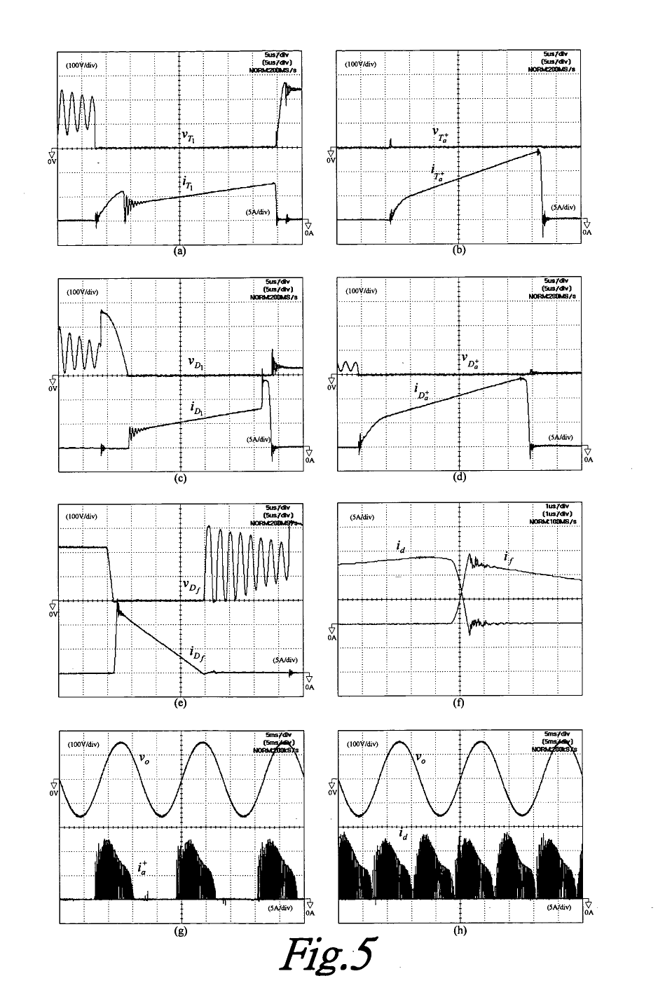

FIG. 5 shows the real voltages and soft-switching current waveforms of switches and diodes in the current-source sine wave voltage driving circuit using voltage-clamping and soft-switching techniques. The waveforms verify the analysis of table 1: FIG. 5(a) is the end to end voltage and current waveforms of voltage-clamping switch T₁; FIG. 5(b) is the end to end voltage and current waveforms of inverter switch Tₐ⁺; FIG. 5(c) is the end to end voltage and current waveforms of diode D₁; FIG. 5(d) is the end to end voltage and current waveforms of diode Dₐ⁺; FIG. 5(e) is the end to end voltage and current waveforms of diode D_{f}; FIG. 5(f) is the crossover waveforms of transformer's primary side current i_{d} and secondary side current i_{d}; FIG. 5(g) is the output AC voltage waveform versus the current waveform of inverter switch Tₐ⁺; FIG. 5(h) is the output AC voltage waveform and waveform of transformer's primary side current i_{d}. From FIG. 5, it is obvious to see the soft-switching characteristics in the embodiment of the present invention, and the effect of control circuit processing zero crossover voltage.

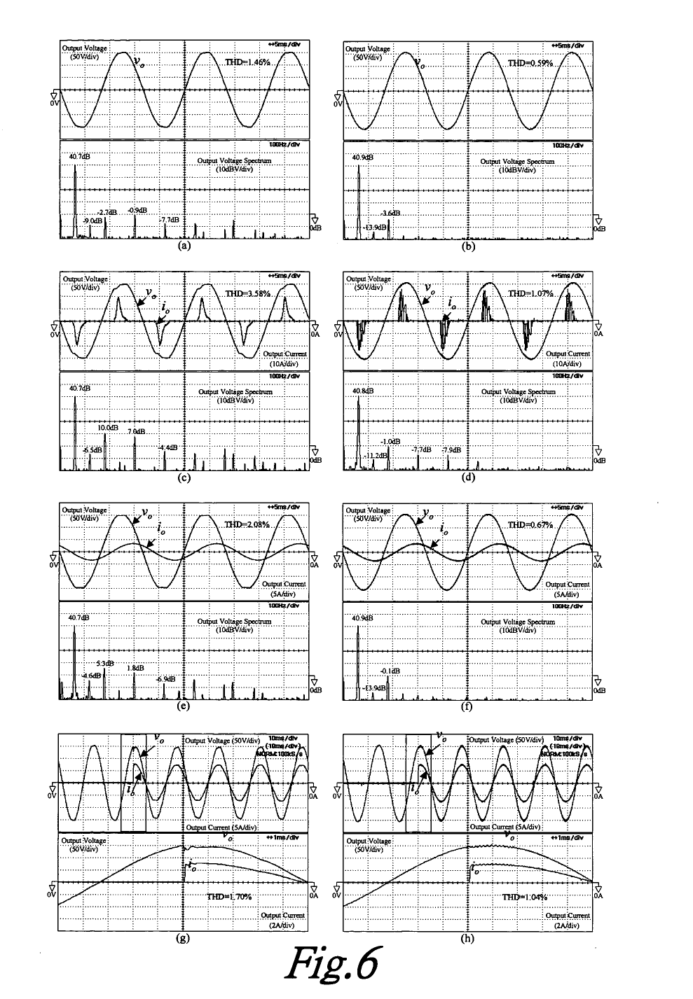

FIG. 6 shows the output voltage and current response waveform versus various loads in the current-source sine wave voltage driving circuit using voltage-clamping and soft-switching techniques, compared with traditional PWM inverter under the same test condition. FIGS. 6 (a), (c), (e) shows the Fourier and THD analysis of traditional PWM inverter, together with the voltage/current waveform of traditional PWM inverter under no load, non-linear rectifying load and inductive load conditions. FIGS. 6 (b), (d), (f) shows the result of the present invention under the same test environment. FIG. 6 (g) is the voltage/current waveforms of traditional inverter having sudden load and its local view. FIG. 6 (h) shows the result waveform of the present invention under the same test environment as in FIG. 6 (g). From the test waveform, the present invention shows less distortion around sine wave peak. Also from the statistics of Fourier analysis and THD, it is obvious that the current-source sine wave voltage driving circuit using voltage-clamping and soft-switching techniques in the present invention can greatly improve the capabilities of traditional PWM inverter.

Compared with traditional devices, the present invention provides a current-source sine wave voltage driving circuit using voltage-clamping and soft-switching techniques, which is advantageous in the following ways:

1.The present invention uses voltage-clamping technique and quasi-resonant property, and controls the inductance current in discontinuous conduction mode so that all semiconductor switches and diodes have the soft-switching characteristics and the maximum convention efficiency is more than 95%.

2. The clamping circuit used in the present invention is able to reduce the voltage specification to be sustained by switches, wherein the rated voltage for switches of clamping circuit drops from 4 times to 2 times the input source voltage, and rated voltage for inverter switches drops from 2 times to the same as input voltage.

3. The value and volume of the inductor used in the current source is smaller than those in the prior-art current-source mechanisms so that the current source can adjust inductive current promptly to satisfy the requirements of supplied loads. In one embodiment, we use EE-55 iron powder core having an inductance value of 300 uHₒ

4. The present invention skips output filter inductor, and the current source charges the output load and filter capacitor directly. Therefore, it is suitable for various inductive, capacitive and nonlinear loads, even for instant load changes, and has better results of Fourier spectrum and output voltage waveform distortion (THD) compared to a traditional PWM scheme.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

1. A driving device for converting DC Voltage into AC sine wave voltage, comprising:
a DC source, a current source circuit, a clamping circuit, an inverter circuit, a control and a driving circuit; said DC source providing input power higher than a peak value of an AC output; said current source circuit using a first inductance of a high exciting current transformer's primary side to limit a first capacitor's charging current of said inverter; said clamping circuit comprising a second inductance of said high exciting current transformer's secondary side, a diode, a power switch and a second capacitor; said driving device controlling a current of said inverter circuit, using voltage-clamping, quasi-resonant techniques and controlling an inductance current in discontinuous conduction mode so that all semiconductor switches and diodes have soft-switching characteristics; said inverter circuit basically guiding a DC inductance current to an AC output capacitor; said control and driving circuit comparing a single-phase voltage and a frequency command with a feedback voltage to determine logically, to delay process, to isolate an amplification driving current, and to trigger and cut-off switches; said driving device having following characteristics:
all switches and diodes have soft-switching characteristics, and most of them provide zero-current-switching (ZCS) and zero-voltage-switching (ZVS) effects, with efficiencies higher than 95%;
said clamping circuit used in said driving device reducing a voltage specification to be sustained by switches;
a value and volume of said inductor used in said current source being smaller than those in a prior-art current-source mechanism so that said current source can adjust an inductive current promptly to satisfy requirements of supplied loads;
an output of said driving device having no output filter inductors;
said driving device being suitable for various inductive, capacitive and nonlinear loads, even for sudden load changes, and better results of Fourier spectrum and output voltage waveform distortion (THD) compared to a traditional PWM (pulse width modulation) scheme.

2. The driving device of claim 1, wherein said control and driving circuit comprises a feedback control circuit, a phase splitting circuit, a logic control circuit, an isolating and current amplification driving circuit; said feedback control circuit providing a low-pass filter circuit to remove high frequency noises from a first signal and input said first signal to a comparator; said comparator outputting a second signal to said phase splitting circuit and said second signal being split to two sets of signals having a phase difference of 180 degrees; each set of signals passing through two cascaded resistor-diode circuits, which form one stage RC discharging circuits with a same capacitor respectively to provide rise and fall delays to two sets of signals, and further provide turn-on and cut-off time delays via said inverter, meanwhile providing a lockout time needed for an upper path and a lower path of inverter switches to interlock each other; a circuit comprising two cascaded diodes and one capacitor to extend a turn-on time of another set of signals to deal with zero crossover voltage swing in a low load situation; said two sets of signals providing first trigger signals to four pre-amps of said inverters; said logic control circuit using an AND gate of said phase splitting circuit to clear a cut-off delay time and to provide second trigger signals to two switches of said clamping circuit; six sets of isolating and current amplification driving circuits driving six independent switches to avoid a common-ground short-circuit phenomenon.

3. The driving device of claim 1, wherein the DC source comprises a fuel cell, solar energy and a battery, one or more batteries, an AC-to-DC and DC-to-AC inverters.

4. The driving device of claim 1, when a transformer of said clamping circuit having a 1-to-1 ratio for a primary side's inductance value and a secondary side's inductance value, a maximum voltage value to be sustained by said clamping circuit is twice a value of said DC source, therefore, changing a ratio for said primary side's inductance value and said secondary side's inductance value will change said voltage specification to be sustained by switches.

5. The driving device of claim 1, wherein said clamping circuit is using voltage-clamping, quasi-resonant techniques and is controlling said inductance current in discontinuous conduction mode so that when switches/diodes in said clamping circuit are on/off, the switches/diodes respectively have ZVS or ZCS switching characteristics; other switches and diodes all have both ZVS and ZCS switching characteristics; said driving device being applicable to other soft-switching circuits.

6. The driving device of claim 2, wherein said phase splitting circuit is using all kinds of delay techniques to process a control signal required by said inverter; said driving device is comprised of said phase splitting circuit to control a crossover AC voltage signal.

7. The driving device of claim 1, wherein said inverter circuit generates single-phase 60 Hz sine wave voltage.

8. The driving device of claim 1, wherein said inverter circuit comprises a crossover DC capacitor to form a buck converter.
